(19) United States
(12) Patent Application Publication
(10) Pub. No.: US 2010/0306553 A1
(43) Pub. Date: Dec. 2, 2010

(54) High-throughput cryptographic processing using parallel processing

(76) Inventor: Joseph William Poletti, III, Fairview Heights, IL (US)

Correspondence Address: Joseph W. Poletti, 5358 Tulane Court, Fairview Heights, IL, 62208, US

(21) Appl. No.: 12/799,969

(22) Filed: May 6, 2010

Related U.S. Application Data
(60) Provisional application No. 61/217,262, filed on Jun. 1, 2009.

(51) Int. Cl. G06F 21/22; H04L 9/00

(52) U.S. Cl. 713/189; 380/277

(57) ABSTRACT

This invention uses parallel processing to bring greater efficiencies to cryptographic processing of large amounts of data. This technique is scalable, can be applicable for protection of internet data, data moving between data processing centers, data in motion, data going into storage, data coming out of storage and similar large processing operations.

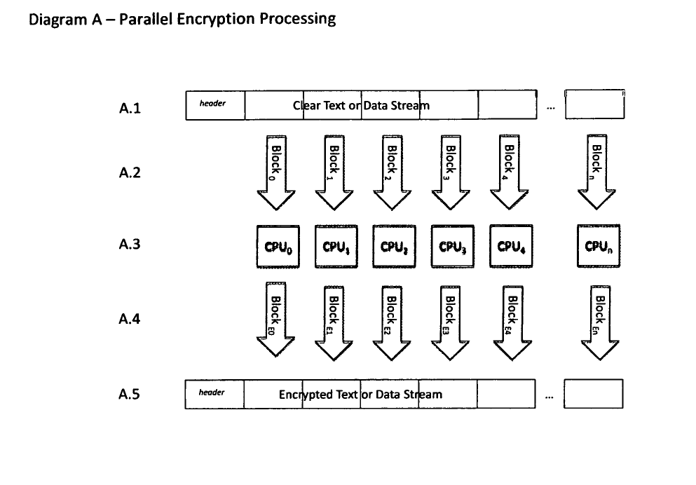

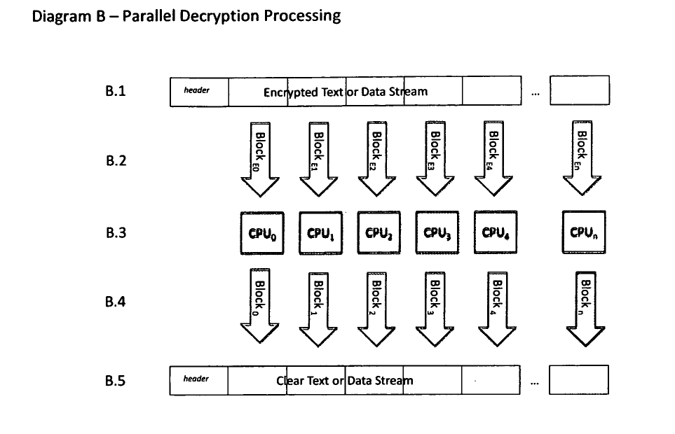

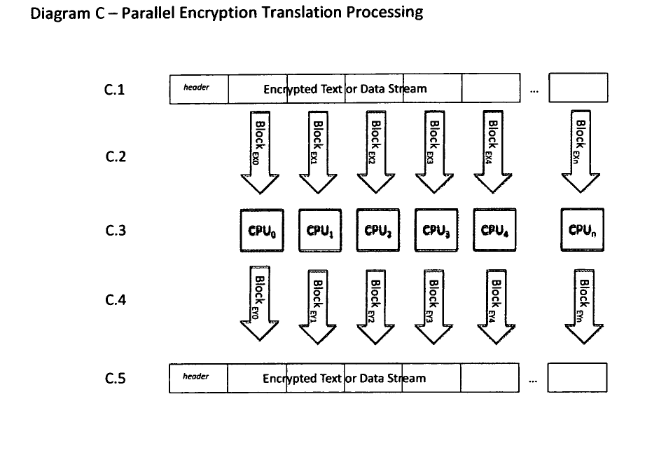

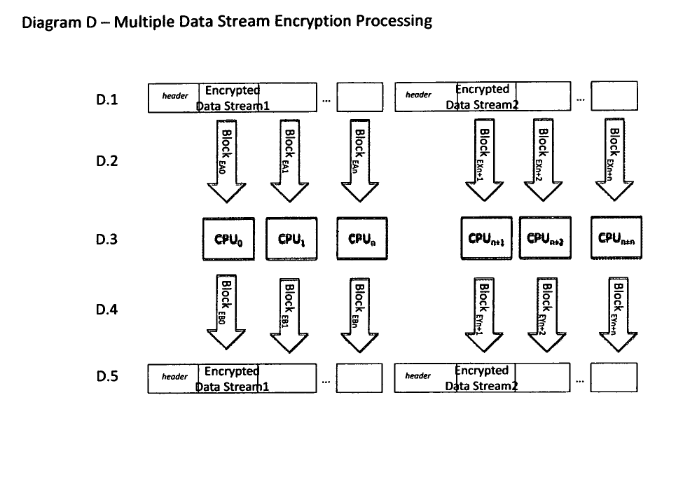

### BACKGROUND

Data privacy issues are increasing the volume of data requiring encryption both in transport and at rest. The use of single-threaded cryptographic processing can create bottlenecks in data flow. The transmittal of large amounts of sensitive data using single-threaded cryptographic processing is limited by the throughput of the single cryptographic processor. High-speed connections between facilities using singled-threaded cryptographic processing are limited in speed based on the throughput of the cryptographic processing unit.

In an environment where encryption is required for large volumes of data, it may be advantageous to modify the encryption processing stream to split similar processing activity across two or more computer CPUs.¹ The CPUs would be performing similar activities on different data blocks. For example, if multiple data blocks were scheduled for the same cryptographic operation, rather than being processed by a single CPU in a serial fashion, they would be processed by two or more CPUs performing cryptographic operation in parallel. This type of operation would be scalable up to as many parallel processors as required to reach the desired throughput speed. ¹CPU is defined as integrated circuit computer central processing unit or cryptographic processing unit containing a single core, or, in the case of “multi-core CPUs,” one individual integrated circuit central processing units' core.

This technique is independent of any cryptographic algorithm or data stream. This description applies to data streams as they enter, traverse or complete transmission across networks, and to data being prepared for storage or being recovered from storage. Whether to use dedicated cryptographic processing units (secure cryptographic hardware) as a part, or all, of the processor array is at the option of the implementer. Risk will determine the security of a specific implementation.

The following describes the use of parallel processors and/or processes to improve both the speed and volume capabilities of cryptographic operation.

### SUMMARY OF THE INVENTION

This patent applies to the use and management of parallel processing of cryptographic operations across multiple CPUs for purposes of encrypting data, decrypting data and for translation from one encryption scheme, key or technique to another. Parallel cryptographic processing of multiple data blocks increases throughput by dividing the effort to encrypt those blocks into parallel single-threaded or multi-threaded processes, dividing the processing required across multiple CPUs. The management of the data being presented for processing, the scheduling of the data, assigning data, cryptographic algorithms and keying material to individual processors, and the reconstruction of data strings by a process manager are key to the invention.

### DESCRIPTION OF DRAWINGS

Diagram A—This illustration describes the parallel processing of multiple clear text data blocks being encrypted.

Diagram B—This illustration describes the parallel processing of multiple encrypted text data blocks being decrypted.

Diagram C—This illustration describes the parallel processing of multiple encrypted text data blocks being translated to a different form of encryption.

Diagram D—This illustration describes the parallel cryptographic processing of multiple data streams or elements.

### DESCRIPTION OF INVENTION

Parallel Encryption Processing

Using Diagram A, a string of data is received into an input buffer or computer memory shown in Diagram A, Step A.1 as Clear Text or Data Stream. The data is analyzed by the software process manager to determine the cryptographic operation needed on the data. The cryptographic operation information may also be passed to the process manager by an external application through a message header or other means not described. If one does not exist, the process manager may create and assign a message header to track the data through the system. Based on the data being processed and the data block size required for that processing, the process manager may break up the data string into individual blocks of data for processing. These blocks are shown in Diagram A, Step A.2 as Block₀ through Blockₙ. The process manager determines specific cryptographic algorithm(s) and keys to be used to process the data. Information related to the data block including data stream or source, block size, sequence information, cryptographic operation and other related information is stored in computer memory to track the data block(s). The process manager records the information related to processing data in memory along with processing sequence information to keep the data in the correct sequence after the cryptographic processing is complete.

The process manager either loads the appropriate cryptographic processing software into memory for the processors in the array that will process the individual blocks or signals the processors which cryptographic software that will be used in processing the individual data blocks. These processors are shown in Diagram A, Step A.3 as CPU₀ through CPUₙ. The process manager sends the data block and cryptographic keys to the processor and signals the processor to process the data block. This process is performed for each applicable data block.

The processor(s) send(s) the process manager the resulting encrypted data block(s) as shown in Diagram A, Step A.4 as Block_{E0} through Block_{En} or stores the encrypted data block(s) in a designated memory location. The process manager accesses the data and constructs an encrypted data string in the appropriate sequence based on the sequence-related information stored earlier as shown in Diagram A, Step A.5 as Encrypted Text or Data stream.

If the data was sent to the process manager with a header, the header is modified, if necessary, and placed in the appropriate position in the data string. The data string is moved to the output buffer and sent to the requesting application or passed to the next logical process and may contain algorithm and key identification information.

Memory related to clear text and intermediate processing data is cleared. Cryptographic keys may be cleared if no longer needed. Optionally, other memory, process registers and cryptographic algorithms related to the processing of the data and intermediate value of the data during cryptographic processing may be cleared.

The process is repeated for data in the string and for data related to other strings. The process is continuous and triggered for on-demand processing. If there are more data blocks to be processed than there are available CPUs, the data blocks are queued for processing when CPUs are available.

Parallel Decryption Processing

Using Diagram B, a string of data is received into an input buffer or computer memory shown in Diagram B, Step B.1 as Encrypted Text or Data Stream. The data is analyzed by the software process manager to determine the cryptographic operation needed on the data to decrypt the data into cleartext. This information may also be passed to the process manager by an external application through a message header or other means not described. If one does not exist, the process manager may create and assign a message header to track the data through the system. Based on the data being processed and the data block needed for that processing, the process manager breaks up the data string into individual blocks of data for processing. These blocks are shown in Diagram B, Step B.2 as Block_{E0} through Block_{En}. Information related to the block including related data string, block size, sequence number, and other related information is stored in computer memory to track the data block(s). This information is used to ensure proper processing and correct data string sequence after the cryptographic processing is completed.

The process manager determines cryptographic algorithm(s) and cryptographic key(s) to be used to process the data. The process manager either loads the appropriate cryptographic processing software and key(s) or key information into memory for the processors in the array that will process the individual blocks or signals the processors which cryptographic software that will be used in processing the individual data blocks. These processors are shown in Diagram B Step B.3 as CPU₀ through CPUₙ. The process manager sends the data block and cryptographic keys to the processor and signals the processor to process the data block. This process is performed for each applicable data block.

The processor(s) send(s) the process manager the resulting decrypted data block(s) as shown in Diagram B, Step B.4 as Block₀ through Blockₙ or stores the decrypted data block(s) in a designated memory location. The process manager accesses the data and constructs a decrypted data string in the appropriate sequence based on the sequence-related information stored earlier as shown in Diagram B, Step B.5 as Clear Text or Data stream.

If the data was sent to the process manager with a header, the header is modified, if necessary, and placed in the appropriate position in the data string. The data string is moved to the output buffer and sent to the requesting application or passed to the next logical process and may contain algorithm and key identification information.

Memory related to cryptographic keys and clear text data is cleared. Optionally, other memory and process registers related to the processing of the data and intermediate value of the data during cryptographic processing may be cleared.

The process is repeated for data in the string and for data related to other strings. The process is continuous and triggered for on-demand processing. If there are more data blocks to be processed than there are available CPUs, the data blocks are queued for processing when CPUs are available.

Parallel Encryption Translation Processing

To support multiple encryption schemes and or cryptographic keys applied to the same data, cryptographic processing may be used to translate² data between different encryption key sets, algorithms or both. For example, to prepare data from storage for transmission to another location, the security needs may require the decryption from an internal key and encryption using a shared key. If the data is being received for storage, the requirement may be for decryption using a shared key and encryption using an internal key and/or algorithm. ² Translation is the process by which data encrypted in one cryptographic key and/or algorithm is changed so that that same data is encrypted in a different cryptographic key and/or algorithm.

Diagram C illustrates blocks of data (represented by Block_{EX0} through Block_{EXn}) in a stream of data, encrypted using one key and/or algorithm, is translated such that the blocks of data (represented by Block_{EY0} through Block_{EYn}) in a stream of data are encrypted using a second key. This decryption and encryption translation process for each individual block typically takes place within the same processor or process but may be assigned to separate processors (or processes). A process manager assigns the blocks of data to available processors (or processes) and then reassembles the data into the appropriate data streams after the key translation action is complete.

To describe the process in more detail, the flow of data and processing follows process described first in Parallel Decryption Processing as depicted in Diagram B, followed by the Parallel Encryption processing as depicted in Diagram A.

Using Diagram B, a string of data is received into an input buffer or computer memory shown in Diagram B, Step B.1 as Encrypted Text or Data Stream. The data is analyzed by the software process manager to determine the cryptographic operation needed on the data to decrypt the data into cleartext. This information may also be passed to the process manager by an external application through a message header or other means not described. If one does not exist, the process manager may create and assign a message header to track the data through the system. Based on the data being processed and the data block needed for that processing, the process manager breaks up the data string into individual blocks of data for processing. These blocks are shown in Diagram B, Step B.2 as Block_{E0} through Block_{En}. Information related to the block including related data string, block size, sequence number, and other related information is stored in computer memory to track the data block(s). This information is used to ensure proper processing and correct data string sequence after the cryptographic processing is completed.

The process manager determines cryptographic algorithm(s) and cryptographic key(s) to be used to process the data. The process manager either loads the appropriate cryptographic processing software and key(s) or key information into memory for the processors in the array that will process the individual blocks or signals the processors which cryptographic software that will be used in processing the individual data blocks. These processors are shown in Diagram B, Step B.3 as CPU₀ through CPUₙ. The process manager sends the data block and cryptographic keys to the processor and signals the processor to process the data block. This process is performed for each applicable data block.

The processor(s) send(s) the process manager the resulting decrypted data block(s) as shown in Diagram B, Step B.4 as Block₀ through Blockₙ or stores the decrypted data block(s) in a designated memory location. The process manager accesses the data and constructs a decrypted data string in the appropriate sequence based on the sequence-related information stored earlier as shown in Diagram B, Step B.5 as Clear Text or Data stream.

If the data was sent to the process manager with a header, the header is modified, if necessary, and placed in the appropriate position in the data string. The data string is moved to the output buffer and sent to the requesting application or passed to the next logical process and may contain algorithm and key identification information.

Optionally, memory and process registers related to the processing of the data and intermediate value of the data during cryptographic processing may be cleared.

The data string that is output from this process is used as input that is recorded in computer memory or the input buffer into the encryption process.

For purposes of this explanation, the data that is depicted in Diagram B Step B.5 is the input data stream in Diagram A Step A.1.

The string of decrypted data from the previous step is analyzed by the process manager to determine the next encryption operation needed on the data to complete the translation. Optionally, this information may be determined prior to the decryption process described earlier. This information may also be passed to the process manager by an external application through a message header or other means not described. Based on the data being processed and the data block size needed for that processing, the process manager breaks up the data string into individual blocks of data for processing. These blocks are shown in Diagram A, Step A.2 as Block₀ through Blockₙ. Information related to the block including block size, sequence number, cryptographic operation and other related information is stored in computer memory to track the data block(s). Information related to the data block including data stream or source, block size, sequence information, cryptographic operation and other related information is stored in computer memory to track the data block(s). The process manager records the information related to processing data in memory along with processing sequence information to keep the data in the correct sequence after the cryptographic processing is complete.

The process manager either loads the appropriate cryptographic processing software into memory for the processors in the array that will process the individual blocks or signals the processors which cryptographic software that will be used in processing the individual data blocks. These processors are shown in Diagram A Step A.3 as CPU₀ through CPUₙ. The process manager sends the data block and cryptographic keys to the processor and signals the processor to process the data block. This process is performed for each applicable data block. is process may have been performed earlier in the process depending on the capabilities of the CPUs and whether the data needs to be resized for the cryptographic algorithm used.

The processor(s) send(s) the process manager the resulting encrypted data block(s) as shown in Diagram A, Step A.4 as Block_{E0}through Block_{En}. The process manager constructs an encrypted data string in the appropriate sequence based on the sequence-related information stored earlier as shown in Diagram A, Step A.5 as Encrypted Text or Data stream.

If the data was sent to the process manager with a header, the header is modified, if necessary, and placed in the appropriate position in the data string. The data string is moved to the output buffer to be returned to the requesting application or passed to the next logical process along with the necessary algorithm and key identification information.

Multiple Data Stream Encryption Processing

Cryptographic processing, as shown in Diagram D, illustrates how a process manager can schedule individual blocks of data as part of multiple data streams across the processor (or process) array.

In Diagram D, two data streams are illustrated to show how the parallel processing can handle concurrent actions on two or more independent/unrelated data components. In this example, blocks of data from Data Stream1 and Data Stream2 are translated from one key for Block_{EA0} through Block_{EAn} and a second key for Block_{EXn+1} through Block_{EXn+n} respectively, to a third key for Block_{EB0} through Block_{EBn} and fourth key for Block_{EYn+1} through Block_{EYn+n} respectively. Data from one stream is queued for processing at the same time as data from a second stream. A process manager assigns the blocks of data to available processors (or processes) and then reassembles the data into the appropriate data streams after the key translation action is complete.

Multiple data stream processing encompasses the previously described techniques performed in a concurrent manner.

1. Parallel cryptographic processing of data streams using an array of processors encompassing:
a. The division of an input data stream or streams into data blocks sized appropriately to the cryptographic algorithm
b. Assignment each individual data block to a processor within the array for concurrent crypto processing
c. Presentation of individual data blocks to the assigned processors within the array along with keys, etc.
d. Reconstruction of the data stream using the resulting post-crypto processing data blocks

2. Process as described in claim 1 encompasses decryption requests

3. The process described in claim 1 may be used for the translation of data from one cryptographic key and/or algorithm to a different cryptographic key and/or algorithm.

4. Cryptographic processing as described in claim 1 is intended to be algorithm independent.

5. Cryptographic algorithm as described in claim 1 is intended to be data state independent.

6. Any processing request as described in claim 1 would be assigned to any available processor in the array regardless of whether the processor is performing some type of processing or not.

7. A process manager in support of one or more of the following functions required for claim 1.
a. Receives data stream to be acted upon
b. Receives/retrieves algorithm information and other algorithm-dependent data (e.g. initialization vector)
c. Retrieves appropriate cryptographic key(s)
d. Stores information acquired in steps a through c to be used by other tasks, passes same data to process manager defined in claim 8.
e. Accesses the data stored in claim 7 or other sources.
f. Divides the data stream into blocks consistent with the target block size used by the cryptographic algorithm to be used (as identified in claim 7 or elsewhere).
g. Determines the number of processors required to act on the data blocks
h. Allocates processors from the parallel array. If there are insufficient processors available to process all of the blocks in parallel, then schedules processing as processors in the array are available
i. Assigns data blocks, cryptographic key(s) and algorithm-dependent data to the processors
j. Records the data block sequence as assigned to the processors
k. Triggers processing in the assigned processors in the array
l. Retrieves post-processing data blocks and arranges them in the proper sequence creating an output data stream in memory for use by the application requesting cryptographic processing
